(19) United States
(12) Patent Application Publication
(10) Pub. No.: US 2011/0262311 A1
(43) Pub. Date: Oct. 27, 2011

(54) FILTRATION STRUCTURE HAVING INLET AND OUTLET SURFACES WITH A DIFFERENT PLUGGING MATERIAL

(75) Inventor: Matthias Schumann, Plan d'Orgon (FR)

(73) Assignee: SAINT-GOBAIN CENTRE DE RECH. ET D'ETUDES EUROPEEN, Courbevoie (FR)

(21) Appl. No.: 13/141,854

(22) PCT Filed: Dec. 22, 2009
(86) PCT No.: PCT/FR09/52659

§ 371 Date: Jun. 23, 2011

(30) Foreign Application Priority Data
Dec. 23, 2008 (FR) 0858998

(51) Int. Cl. B01D 53/94; B29D 99/00; B28B 1/00; B01D 46/24; F01N 3/022

(52) U.S. Cl. 422/177; 55/524; 55/523; 55/385.3; 264/630

(57) ABSTRACT

The invention relates to a filtering structure of the honeycomb type, comprising an array of longitudinal adjacent channels of mutually parallel axes separated by porous filtering walls, said structure being characterized in that the material constituting the plugs placed on the first end of the filter have substantially the same composition and are structuring continuous with said walls and in that the plugs placed on the second end of the filter have a different chemical composition and/or a different structural composition from those/that of the plugs placed on said first end.

The invention relates to the field of filtering structures, optionally catalytic filtering structures, used especially in an exhaust line of an internal combustion engine of the diesel type.

Catalytic filters for the treatment of exhaust gases and removal of soot coming from a diesel engine are well known in the prior art. These structures usually all have a honeycomb structure, one of the faces of the structure allowing the intake of exhaust gases to be treated and the other face for discharging the treated exhaust gases. The structure comprises, between the intake and discharge faces, an array of adjacent ducts or channels of mutually parallel axes separated by porous walls. The ducts are sealed off at one or the other of their ends in order to define inlet chambers that open onto the intake face and outlet chambers opening onto the discharge face. The channels are alternately sealed off in an order such that the exhaust gases, as they pass through the honeycomb body, are constrained to pass through the side walls of the inlet channels in order to rejoin the outlet channels. In this way, the particulates or soot particles are deposited and accumulate on the porous walls of the filtering body.

As is known, during its use a particulate filter is subjected to a succession of filtration (soot accumulation) and regeneration (soot removal) phases. During the filtration phases, the soot particles emitted by the engine are retained and deposited inside the filter. During the regeneration phases, the soot particles are burnt off inside the filter, so as to restore the filtration properties thereof.

So as in particular to increase the storage volume of particulates or soot particles, and the storage volume of the residues resulting from the combustion of the soot particles and thus increase the time between two regenerations, various filtering structures have already been proposed in the prior art. In particular, structures called hereafter “asymmetric” structures have, for a constant filter volume, an inlet channel surface or volume which is different from that of the outlet channels of said filter. For example, patent application WO 05/016491 has proposed structures in which the wall elements come one after another, in cross section and along a horizontal and/or vertical row of channels, in order to define a sinusoidal or wavy shape. Typically, the wall elements form a wave with a sinusoid half-period over the width of a channel. Such channel configurations make it possible to achieve a low pressure drop and a high soot storage volume. In another construction, patent application EP 1 495 791 has proposed monolith blocks characterized by an octagonal arrangement of the internal inlet channels (often called an “octosquare” structure in the field).

Usually, the filters are made of a porous ceramic, for example cordierite or silicon carbide.

Silicon carbide filters produced with these structures are for example described in patent applications EP 816 065, EP 1 142 619, EP 1 455 923, WO 2004/090294 and WO 2004/065088, to which a person skilled in the art may for example refer for greater explanation and details, both as regards the description of the filters according to the present invention and as regards the process for obtaining them. Advantageously, these filters have a high chemical inertness with respect to the soot particles and to the hot gases, but not a very high thermal expansion coefficient, which means, for producing large-sized filters, having to assemble several monolithic elements into a filtering block by a jointing or grouting cement, so as to reduce their thermomechanical stresses. Because of the high mechanical strength of recrystallized SiC materials, it is possible to produce filters with thin filtering walls of high porosity, with a very satisfactory filtration efficiency.

Cordierite filters have also been used for a long time because of their low cost. Thanks to the very low thermal expansion coefficient of this material, in the normal operating temperature range of a filter, it is possible to produce monolithic filters of larger size.

Aluminum titanate may also have a low thermal expansion coefficient and exhibits both better refractoriness and better corrosion resistance than those of cordierite. Thus, it makes it possible to produce large monolithic filters provided that, however, the thermal stability of aluminum titanate is controlled, especially during the filter regeneration phases. Monolithic filters have thus been described in patent application WO 2004/011124 that provides structures based on 60 to 90 wt % aluminum titanate reinforced with 10 to 40 wt % mullite. According to the authors, the filter thus obtained is more durable. In another construction, patent application EP 1 741 684 discloses a filter having a low expansion coefficient and in which the aluminum titanate main phase is stabilized, on the one hand, by substituting a fraction of the Al atoms with Mg atoms in the Al₂TiO₅ crystal lattice within a solid solution and, on the other hand, by substituting a fraction of the Al atoms on the surface of said solution solid with Si atoms, these being introduced into the structure via an intergranular additional phase of the potassium sodium aluminosilicate type, especially of the feldspar type.

Typically, these monolithic structures are extruded and then sealed off at one or other of their ends so as to define inlet chambers and outlet chambers, as described above.

However, it turns out that the method for sealing or plugging the two faces of an extruded structure, especially one of large size, results in the filters cracking in the zone corresponding to their face bearing on the firing support. The term “large size” is understood in particular in the context of the present invention to mean structures having a diameter greater than 100 mm or a cross section greater than 75 cm².

These cracks are due to stresses deriving from the difference in shrinkage between the channels plugged in the green state, i.e. before the filter is fired, and those that are not plugged. The term “shrinkage” is understood in the context of the present invention to mean the difference between one dimension of the filter, for example its length before and after the firing thereof. This phenomenon may be minimized as long as the mineral formulation of the mixture intended to make the plugs is very close to that of the mixture intended for making the walls of the filter. U.S. Pat. No. 4,455,180 describes for example a process for manufacturing a cordierite-based filtering structure employing compositions of plugs produced by plugging a green structure that have a thermal expansion coefficient high enough to fill the channels but low enough to prevent these channels from fracturing. This cracking problem persists and becomes critical in the case of long filters (i.e., for example, filters with a length greater than 150 mm), or else of very large size (i.e., for example, filters with a diameter greater than 125 mm) or of large cross section (i.e. a cross section greater than or equal to 120 cm²) and/or if the shrinkage of the structure after firing, along its largest dimension, is greater than or equal to 5%.

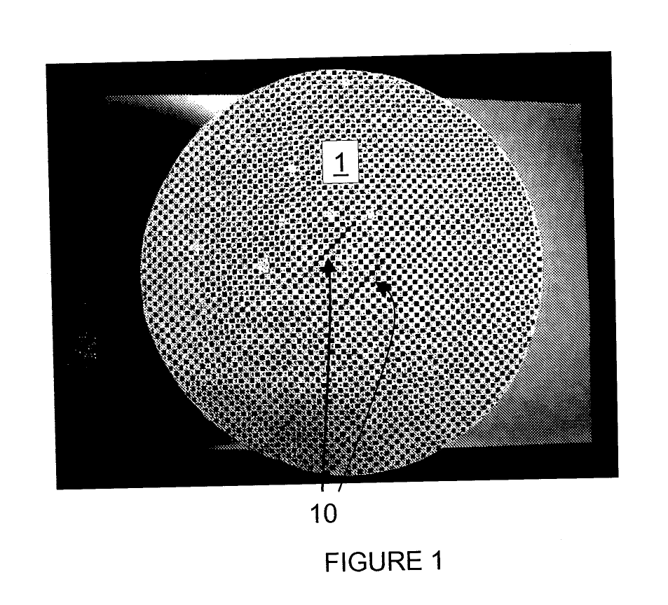

The process of plugging or sealing the channels of an already sintered structure has also been described in the prior art. It constitutes an additional firing or curing step. However, this process results in the appearance of cracks between the plugs and the walls of the sealed-off channels during the additional curing of the structure (see in particular, FIG. 1). This problem may be attributed to a difference in dilatometric behavior between the material constituting the plugs and that of the walls. The solutions proposed hitherto, especially with the aim of adapting the plugging mixture for the purpose of obtaining a dilatometric curve during curing close to that of the already sintered material constituting the walls of the structure, are, however, not satisfactory. In one construction, patent application US 2006/0272306 thus provides a plug formulation for application in a structure based on aluminum titanate or cordierite that involves a curing operation at up to 1000° C. However, the refractoriness of the plugs produced on the sintered structure, i.e. the high-temperature thereof, is too low in the case of the most severe operating conditions, in particular in the case of severe accidental regeneration of the filter. They furthermore lead to insufficient sealing and consequently to a filter of too low a filtration efficiency if the service life of a filter in an automobile exhaust line is taken into account.

In another construction, patent application US 2008/010960 envisions the possibility of making structures of the AlTi type that are either plugged in the green state (i.e. before firing) or are plugged in the fired state (i.e. after firing), using suitable mixture formulations, but this solution is still not satisfactory as it also leads to the probable appearance of cracks over the lifetime of the filter. The object of the present invention is thus to provide a honeycomb filtering structure of a novel type, enabling all of the abovementioned problems to be solved.

In its most general form, the present invention relates to a process for obtaining a filtering structure, for filtering a particulate-laden gas, of the honeycomb type, comprising an array of longitudinal adjacent channels of mutually parallel axes separated by porous filtering walls, said channels being alternately plugged at one or other of the ends of the structure so as to define inlet channels and outlet channels for the gas to be filtered and so as to force said gas to pass through the porous walls separating the inlet channels from the outlet channels, said process comprising at least steps for forming the honeycomb, for firing the honeycomb and for plugging the inlet and outlet channels, said process being characterized in that:
a) one portion of the inlet channels is plugged on a first end before the honeycomb structure has been fired;
b) a portion of the outlet channels is plugged on a second end after the honeycomb structure has been fired.

Advantageously, in the process according to the invention, the materials are chosen in such a way that the material constituting the plugs placed on the first end of the filter has substantially the same composition and is structurally continuous with said walls and in which the plugs placed on the second end of the filter have a different chemical composition and/or a different structural composition from those/that of the plugs placed on said first end.

For example, one process for manufacturing a structure according to the invention comprises the following main steps:
a) preparation of a composition based on the constituent material of the structure and forming of a honeycomb structure, especially by extruding said material through a die;
b) drying of said structure in air using a technique chosen from hot-air drying, microwave drying, freeze drying at a temperature below 130° C., or a combination of said techniques;
c) preparation of a composition of a plugging material and sealing, on a first end of said green structure, of a portion of the channels by said composition;
d) optionally, air drying using a technique chosen from hot-air drying, microwave drying, freeze drying at a temperature below 130° C., or a combination of said techniques;
e) firing of said structure, optionally including an initial binder-removal step;
f) preparation of a plugging material composition and sealing by said composition, on the second end of said fired structure, of the channels not sealed off during step c); and
g) drying and/or heat treatment of the plugs placed on the second end of the fired structure.

Typically, firing step e) is carried out at a temperature between 1300° C. and 1800° C.

Step g) may consist of at least a drying operation chosen from the group formed by air drying, hot-air drying, microwave drying and freeze drying at a temperature below 130° C., or a combination thereof.

Alternately, or in combination, step g) consists of at least one heat treatment at a temperature between 500° C. and 1100° C.

The present invention also relates to a filtering structure that can be obtained by a process as previously described, of the honeycomb type, comprising an array of longitudinal adjacent channels of mutually parallel axes separated by porous filtering walls, said channels being alternately plugged at one or other of the ends of the structure so as to define inlet channels and outlet channels for the gas to be filtered and so as to force said gas to pass through the porous walls separating the inlet channels from the outlet channels, said structure being characterized in that the material constituting the plugs placed on a first end of the filter has substantially the same composition and is structurally continuous with said walls and in which the plugs placed on the second end of the filter have a different chemical composition and/or a different structural composition from those/that of the plugs placed on said first end.

The expression “structurally continuous” is understood, in the conventional sense, to mean that it is no longer possible to establish a clear structural boundary, i.e. a structural discontinuity, between the plugs and the walls.

According to one possible embodiment, the volume of at least one portion of the inlet channels is different, particularly larger, than that of at least one portion of the outlet channels. Advantageously, the filtering structure according to the invention is thus of the “asymmetric” type, i.e. the volume or the area of the inlet channels is different and preferably greater than that of the outlet channels:
the larger area of plugs of the inlet channels is then advantageously favorable to better drying and binder removal whenever the thickness and the density of the plugs is not too high. This thus makes it possible in particular to promote the passage of the gases resulting from binder removal before the plugs and the structure are consolidated by sintering;
the plugs of the outlet channels, which are in contact with the exhaust gas, have a smaller area, thereby reducing their gas permeability for the same plug length. The lower mass of the plugs in comparison with that of the inlet channels is favorable to binder removal and consolidation of the filtering structure.

In a first possible embodiment according to the invention, the porous walls of the filtering structure are made of a material based on aluminum titanate.

In another possible embodiment according to the invention, the porous walls of the filtering structure are made of a material based on SiC and optionally of a ceramic and/or glassy binder matrix, said glassy matrix optionally comprising SiO₂.

In another possible embodiment according to the invention, the porous walls of the filtering structure are made of an alumina-based material.

In another possible embodiment according to the invention, the porous walls of the filtering structure are made of a cordierite-based material.

The expression “based on” is understood to mean that said walls comprise at least 50% by weight, preferably at least 70% by weight, or at least 90% or even 98% by weight of said material.

For example, the material of the plugs of the first end and the material of the plugs of the second end may have different chemical compositions.

Alternatively, the material of the plugs of the first end and the material of the plugs of the second end may have substantially the same chemical composition but a different structural composition, especially because of a different firing or curing temperature.

The filtering structure according to the invention may furthermore include a supported, or preferably unsupported, active catalytic phase typically comprising at least one precious metal, such as Pt and/or Rh and/or Pd and optionally an oxide, such as CeO₂, ZrO₂ or CeO₂—ZrO₂.

Finally, the present invention relates to an exhaust line, comprising a filtering structure as described above, in which the second end constitutes the inlet face for the particulate-polluted exhaust gases and in which the first end constitutes the outlet face for the pollution-free gases.

According to the invention, by plugging or sealing only the inlet channels, before the structure is fired, on the outlet face of the filter with reference to the direction of the gases to be filtered, it is possible to eliminate the cracks that appear while the structure is being fired. This is because, in such a configuration, the bearing face of the structure does not include plugs before the firing, thereby making it possible to reduce or even eliminate the shrinkage stresses. Moreover, the plugged face in the green state, on the opposite side from the bearing face, is therefore more “accessible”, making it easier to remove the water from the mixture forming the plugs during the drying of and the removal of binders from the plugs.

The plugging or sealing of the structure after firing consists in closing the outlet channels on the front face of the filter with reference to the direction of arrival of the exhaust gases to be filtered. This configuration is advantageous because these outlet channel plugs are less thermally and thermo-mechanically stressed when the filter is in operation in an exhaust line and more particularly during the successive regeneration phases of the filter in operation.

Furthermore, according to the invention, since the outlet channels are plugged after firing, it is possible to dispense with one plugging operation, in particular in the case of a filter being scrapped after firing.

Other features and advantageous embodiments of the invention are described in greater detail below.

Advantageously, the plugs of the filtering structure that are produced by sealing the latter before it is fired are at least partly made of a sintered ceramic refractory material identical to that of the filtering walls of the structure so as to obtain, after said firing, structural continuity between the walls and the plugs on the rear face of the filter, i.e. structural homogeneity of the material, especially at the interface between the walls and the plugs. The plugs are preferably made of a material of the same mineralogical composition of the filtering walls, therefore characterized by the presence of the same phases and/or a very similar volume or weight distribution of the crystalline phases present.

The plugs of the filtering structure that are produced by sealing the structure after firing are preferably also at least partly made of a refractory material formed in particular from grains preferably present in the wall material, but, unlike the structure of the previous plugs, these grains, typically with a mean diameter or size between 1 and 100 microns, preferably a mean diameter or size between 10 and 100 microns, need not be bound by a ceramic binding matrix. The term “ceramic binding matrix” is understood to mean a continuous structure between the grains and obtained by firing or sintering so as to consolidate the material constituting the plugs. In one possible embodiment, these plugs produced by sealing after firing are for example formed from inorganic grains or particles bound by an optionally glassy matrix for example and/or by a chemical binder of organic and/or mineral nature.

The term “glassy matrix” is understood in particular to mean a matrix formed by an amorphous or slightly crystalline material comprising at least 30% silica (SiO₂).

The term “chemical binders” is understood to mean chemical binders chosen from the following nonexhaustive list:
organic temporary binders, such as resins, especially thermosetting resins, i.e. those formed from at least one polymer that can be converted by a thermal treatment (heat, radiation) or physico-chemical treatment (catalysis, hardener or curing agent) into an infusible and insoluble material. Thermosetting resins thus assume their final form once they have cured, reversibility being impossible. Thermosetting resins comprise especially phenolic, silicon-based or epoxy resins;
other temporary binders such as cellulose derivatives or lignin derivatives, for example carbomethylcellulose, dextrin, polyvinyl alcohols, polyethylene glycols;
chemical setting agents, such as phosphoric acid, alkali metal polyphosphates or alumina phosphates, or sodium silicate and derivatives thereof;
inorganic binders, such as silica gels or silica in colloidal form, binders based on silica gel and/or alumina gel and/or zirconia gel and chemical setting agents, such as phosphoric acid, aluminum monophosphate, etc.

The plugs produced by sealing the structure before or after firing may optionally include a pore-forming agent, for example one chosen from cellulose derivatives, acrylic particles, graphite particles and blends thereof, these being incorporated into a plugging particle blend so as to create the porosity in order to relax the stresses on the walls and/or possibly lighten the filter. However, the amount must not be too high, for example it must be less than 25% by weight relative to the mineral composition of the plugging mixture so as to provide sufficient sealing.

The plugs produced by sealing the structure after firing may also include other organic additives, such as lubricants or plasticizers.

For example, the structure according to the invention may be based on SiC grains bound by a ceramic matrix obtained by reactive sintering or by a glass-ceramic matrix. The term “SiC-based material” is understood in the context of the present description to mean that said material comprises at least 30% by weight of said material, preferably at least 70% and very preferably at least 98% by weight of said material.

Preferably, the filtering structure is monolithic and the filtering walls are based on an inorganic oxide material, in particular based on aluminum titanate or cordierite or even mullite, or a composite obtained from these materials.

Preferably, the composition of the porous ceramic material comprises 5 to 15% SiO₂ by weight.

Preferably, the composition of the porous ceramic material comprises less than 7.5% MgO by weight and even more preferably less than 5% MgO by weight.

Preferably, the composition of the porous ceramic comprises less than 0.25% of the oxides Na₂O and/or K₂O and/or SrO and/or CaO and/or Fe₂O₃ and/or BaO and/or rare-earth oxides in the form of intentional additions.

In general, the composition of the aluminum-titanate-based porous ceramic may have all the known advantages enabling the aluminum titanate phase to be stabilized. The expression “high-temperature stability” is understood to mean the capability of the aluminum-titanate-based material not to decompose into two phases, namely titanium oxide TiO₂ and aluminum oxide Al₂O₃, under the normal operating conditions of a particulate filter. Conventionally, this property is measured according to the invention by a stability test consisting in determining the phases present in the material, typically by X-ray diffraction, and then by subjecting it to a heat treatment at 1100° C. for 10 hours and checking, using the same method of X-ray diffraction analysis and under the same conditions, for the appearance of alumina and titanium oxide phases at the detection threshold of the equipment.

The material constituting the walls of the structures obtained according to the invention preferably has an open porosity of between 20% and 65%, and preferably between 35% and 60%. In particular, in the particulate filter application, too low a porosity results in too high a pressure drop, whereas too high a porosity leads to too low a mechanical strength. The volume median diameter d₅₀ of the pores constituting the porosity of the material is preferably between 5 and 30 microns, preferably between 8 and 25 microns. In general, in the intended applications, it is generally accepted that too low a pore diameter leads to too high a pressure drop, whereas too high a median pore diameter leads to poor filtration efficiency.

Advantageously, the thickness of the walls is between 0.2 and 1.0 mm, preferably between 0.2 and 0.5 mm. The number of channels in the filtering elements is preferably between 7.75 and 62 per cm², said channels typically having a cross section of about 0.5 to 9 mm².

If the filter consists of assembled monoliths, the cross section of a monolith constituting the assembled structure is square, the width of the monolith being between 30 mm and 50 mm. The jointing material is understood here to mean a moldable composition formed by a particle and/or fiber blend, whether dry or wet, capable of setting and of having a sufficient mechanical strength at room temperature or after drying and/or heat treatment, the temperature of which will not exceed the softening or slumping temperature that defines the refractoriness of the material or materials constituting the monoliths.

The term “moldable” is understood to mean a composition that can undergo plastic deformation necessary for being spread over the mating face of the monoliths and having sufficient adhesion to these elements so as to solidate them or to allow the assembled filter to be handled immediately after the jointing operation or, if this is necessary, after a thermal or chemical treatment or another treatment, such as UV irradiation.

The jointing material preferably comprises particles and/or fibers of a ceramic or refractory material, chosen from non-oxides, such as SiC, aluminum and/or silicon nitride and aluminum oxynitride, or from oxides, especially comprising Al₂O₃, SiO₂, MgO, TiO₂, ZrO₂, Cr₂O₃ or any mixture thereof.

The filter whether or not assembled, preferably has a coating cement fastened to the assembled filter, especially of the same mineral composition as the jointing material so as to reduce the thermomechanical stresses.

The present invention also relates to a catalytic filter obtained from a structure as described above, by deposition, preferably by impregnation, of at least one supported, or preferably unsupported, active catalytic phase typically comprising at least one precious metal, such as Pt and/or Rh and/or Pd and optionally an oxide, such as CeO₂, ZrO₂ or CeO₂—ZrO₂ for the treatment of polluting gases of the CO or HC and/or NOx type and/or for the combustion of soot. Such a filter is applicable in particular as the catalyst support in an exhaust line of a diesel or gasoline engine or as a particulate filter in an exhaust line of a diesel engine.

The filtering device comprising the filter may also include, around the filter, a fibrous mat preferably formed from inorganic fibers so as to impart the thermal insulation properties required by the application. The inorganic fibers are preferably ceramic fibers, such as alumina, mullite, zirconia, titanium oxide, silica, silicon carbide or silicon nitride fibers, or else glass fibers, such as R-glass fibers. These fibers may be obtained by fiberizing starting from a bath of molten oxides, or from a solution of organometallic precursors (sol-gel process). The fibrous mat is preferably non-intumescent. Advantageously, it is in the form of a needle felt.

As described above, the invention relates to a process for manufacturing a particulate filter as described above. Such a process comprises the steps described above.

For example, said structure according to the invention may also be obtained from an initial blend of aluminum-titanate-based and/or cordierite-based grains. Advantageously, according to this embodiment, the aluminum-titanate-based or cordierite-based powder has a median diameter of less than 60 microns.

The term “median diameter”, or d₅₀, of a particle blend or a cluster of grains, is understood in the context of the present description to mean the size that divides the particles of this blend or the grains of this cluster into first and second populations equal in volume, these first and second populations having only particles or grains with a size greater than and with a size less than this median diameter respectively.

The manufacturing process according to the invention usually comprises, conventionally, a step of mixing the initial powder blend into a homogenous product in the form of a paste, a step of extruding a green product formed through a suitable die, so as to obtain honeycomb monoliths, a step of drying the monoliths obtained, optionally an assembly step, and a firing step carried out in air or in an oxidizing atmosphere at a temperature not exceeding 1800° C., preferably not exceeding 1650° C.

The plugging steps c) and f) may be carried out according to the process described for example in U.S. Pat. No. 4,557,773 or for example EP 1 500 482. The plugging mixtures are wet or dry particle blends capable of setting. The setting or curing of these blends after the channels of the structure have been closed off may result from the drying or, for example the curing of a resin. Finally, when heating, it is possible to increase the rate of evaporation of the residual water or liquid after curing.

The plugging mixtures according to the invention may especially comprise refractory powders, hollow inorganic spheres, plasticizers, dispersants, lubricants, temporary binders of an organic and/or inorganic nature, chemical binders and pore-forming agents, such as those cited above, but also other forming and/or sintering additives.

All the refractory powders conventionally used for producing a plugging mixture may be used, taking into account, of course, the composition of the material constituting the filtering walls. The refractory powders may in particular be powders based on silicon carbide and/or alumina and/or zirconia and/or silica and/or titanium oxide and/or magnesia, or mixed powders, especially mixed aluminum titanate or mullite powders. Preferably, the refractory powders are fused products. It is also possible to use sintered products.

The term “powder” is conventionally understood in the context of the present invention to mean a collection of grains or particles characterized by grain or particle size distribution or diameter centered on and distributed around a mean or median diameter. The expression “grains or particles” is understood to mean individual solid products in a powder or a powder blend.

Preferably the refractory powders represent more than 50%, preferably more than 70%, of the mass of the dry mineral matter of the plugging mixture.

In a preferred embodiment, the plugging mixture comprises at least or several aluminum titanate powders which represent at least 50%, preferably at least 80%, by weight of the particulate mixture.

According to an alternative embodiment, the plugging mixture of the structure before firing may comprise aluminum titanate precursor powders, especially alumina and titanium powders, which are converted to aluminum titanate while the structure is being fired.

The invention and its advantages will be better understood on reading the following nonlimiting examples. In the examples, all the percentages are given by weight.

### ILLUSTRATIVE EXAMPLES

### a) Production of a Powder Obtained from Fused-Cast Aluminum Titanate

In all the examples, the percentages are given by weight. In a preliminary step, aluminum titanate was prepared from the following raw materials:
about 40% alumina by weight, with an Al₂O₃ purity level greater than 99.5% and a median diameter d₅₀ of 90 μm, sold under the reference AR75® by Pechiney;
about 50% titanium oxide by weight, in rutile form, comprising more than 95% TiO₂ and about 1% zirconia and having a median diameter d₅₀ of about 120 μm, sold by Europe Minerals;
about 5% silica by weight, with an SiO₂ purity level greater than 99.5% and a median diameter d₅₀ of around 210 μm, sold by SIFRACO; and
about 4% by weight of a magnesia powder with an MgO purity level greater than 98%, more than 80% of the particles of which having a diameter between 0.25 and 1 mm, sold by Nedmag.

The initial blend of reactive oxides was melted in an electric arc furnace, in air, under oxidizing electrical operation. The molten mixture was then cast into a CS mould so as to achieve rapid cooling. The product obtained was milled and screened in order to obtain powders of various particle size fractions. More precisely, the milling and screening operations were carried out under conditions for obtaining in the end the following two particle size fractions:
a particle size fraction characterized by a median diameter d₅₀ substantially equal to 50 microns, denoted by the term “coarse” fraction according to the present invention; and
a particle size fraction characterized by a median diameter d₅₀ substantially equal to 1.5 microns, denoted by the term “fine” fraction according to the present invention.

In the context of the present description, the median diameter d₅₀ denotes the particle diameter, measured by sedigraphy, below which 50% by volume of the population lies.

Microprobe analysis showed that all the grains of the fused phase thus obtained have the following composition, in percentages by weight of the oxides below (Table 1):

TABLE 1

| Al₂O₃ | TiO₂ | MgO | SiO₂ | CaO | Na₂O | K₂O | Fe₂O₃ | ZrO₂ | TOTAL |
|---|---|---|---|---|---|---|---|---|---|
| 40.5 | 48.5 | 3.98 | 4.81 | 0.17 | 0.15 | 0.47 | 0.55 | 0.85 | 100.00 |

### b) Manufacture of Green Monoliths

Firstly, a series of dry green monoliths was synthesized in the manner below.

Powders were blended according to the following composition in a mixer:
100% of a blend of two aluminum titanate powders produced beforehand by fuse casting, namely about 75% of a first powder with a median diameter of 50 μm and 25% of a second powder with a median diameter of 1.5 μm.

Next, the following were added, relative to the total mass of the blend:
4% by weight of an organic binder of the cellulose type;
15% by weight of a pore-forming agent;
5% of a plasticizer derived from ethylene glycol;
2% of a lubricant (oil);
0.1% of a surfactant; and
about 20% of water so as to obtain, using the techniques of the prior art, a homogenous paste after mixing, the plasticity of which enabled a honeycomb structure to be extruded through a die, which structure, after being fired, had the dimensional characteristics as in Table 2.

Next, the green monoliths obtained were dried by microwave drying for a time sufficient to bring the chemically nonbonded water content to less than 1% by weight. The population of dry green monoliths was divided into three series representative of this population.

### Example 1

### Comparative Example

In a first series of monoliths produced in this way, the channels of both ends of the monolith were plugged using well-known techniques, for example those described in U.S. Pat. No. 4,557,773, with a mixture satisfying the following formulation:
100% of a blend of two aluminum titanate powders produced beforehand by fuse casting, namely about 66% of a first powder with a median diameter of 50 μm and 34% of a second powder with a median diameter of 1.5 μm;
1.5% of an organic binder of the cellulose type;
21.4% of a pore-forming agent;
0.8% of a dispersant based on a carboxylic acid; and
about 55% of water so as to obtain a mixture capable of sealing the monoliths on every other channel.

The monoliths were then fired in air progressively until a temperature of 1450° C. was reached, this being maintained for 4 hours. The structure of these monoliths according to Example 1 consisted of aluminum titanate having the characteristics given in Table 2.

### Example 2

### Comparative Example

A second series of dry green monoliths was fired without the channels having been plugged, in air, progressively until a temperature of 1450° C. was reached, this being maintained for 4 hours.

The monoliths were then plugged after firing, in the conventional checkerboard configuration (on every other channel), with a plugging mixture satisfying the following formulation:
100% of a blend of two aluminum titanate powders produced beforehand by fuse casting, namely about 66% of a first powder with a median diameter of 50 μm and 34% of a second powder with a median diameter of 1.5 μm;
31% of Elkem 971U silica;
25% of soda-lime glass powder ST300 from Reidt, having a median diameter of 22 μm;
1.5% of an organic binder of the cellulose type;
0.6% of a dispersant based on carboxylic acid; and
about 45% of water.

The alternately (one channel in two) plugged monoliths were then subjected to a heat treatment up to a final temperature of 1000° C., which was maintained for 1 hour. The structure of these monoliths according to Example 2 consisted of aluminum titanate having the characteristics given in Table 2 below.

### Example 3

### According to the Invention

Unlike Example 2, the third series of dry green monoliths was plugged with the plug mixture according to Example 1 only on one end, this being the end on the opposite side from the face for bearing on the firing support. These monoliths were then fired in air progressively until a temperature of 1450° C. was reached, which was maintained for 4 hours. The fired monoliths were then plugged on the end or face that bore on the firing support using a plugging mixture according to Example 2 and were then subjected to a heat treatment up to a final temperature of 1000° C., which was maintained for 1 hour.

The structure of these monoliths according to Example 3 consisted of aluminum titanate having the characteristics given in Table 2 below.

TABLE 2

| | Example | | |
|---|---|---|---|
| | 1 | 2 | 3 |
| Plugging | in the green | in the fired | in the |
| | state on | state on | green state |
| | both ends of | both ends of | on the end |
| | the monoliths | the | opposite |
| | | monoliths | the bearing |
| | | | face and, |
| | | | after |
| | | | firing, on |
| | | | the other |
| | | | face |
| Characteristics of the | | | |
| structure after firing: Wall | | | |
| thickness (μm) | 320 | 320 | 320 |
| Length (mm) | 152 | 152 | 152 |
| Diameter (mm) | 144 | 144 | 144 |
| Median pore diameter | 13 μm | 13 μm | 13 μm |
| Porosity | 44% | 44% | 44% |
| Shrinkage of the filter | 9% | 9% | 9% |
| on being fired | | | |
| Cracks | on the filter | between the | none |
| | | walls and | |
| | | the plugs | |

The porosity characteristics were measured by high-pressure mercury porosimetry analysis carried out with a micromeritics 9500 porosimeter.

As shown in FIG. 1, cracks 10 were observed on the filter 1 according to Example 1, this figure being a view of the filter from the bearing face.

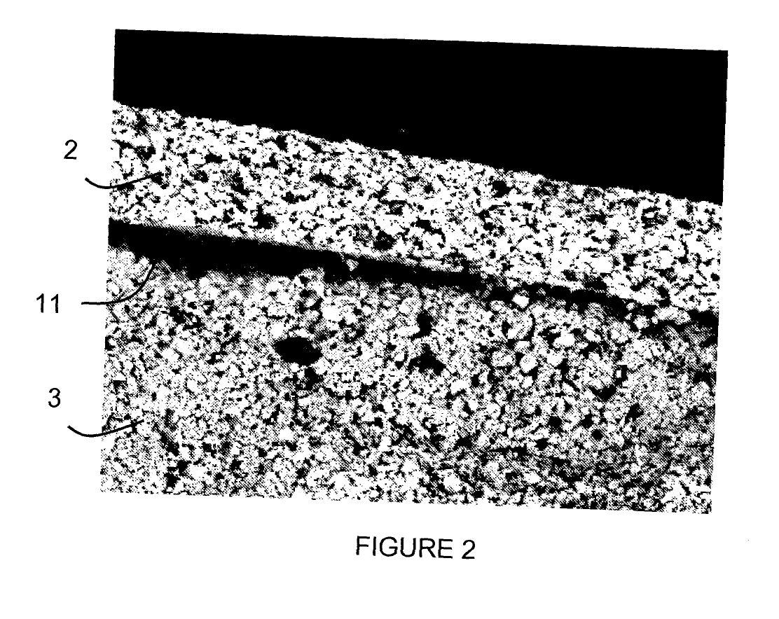

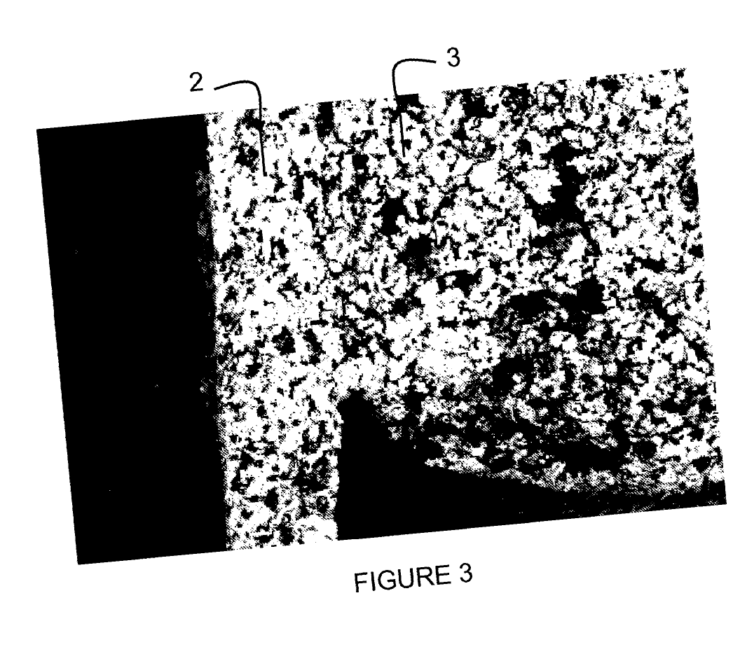

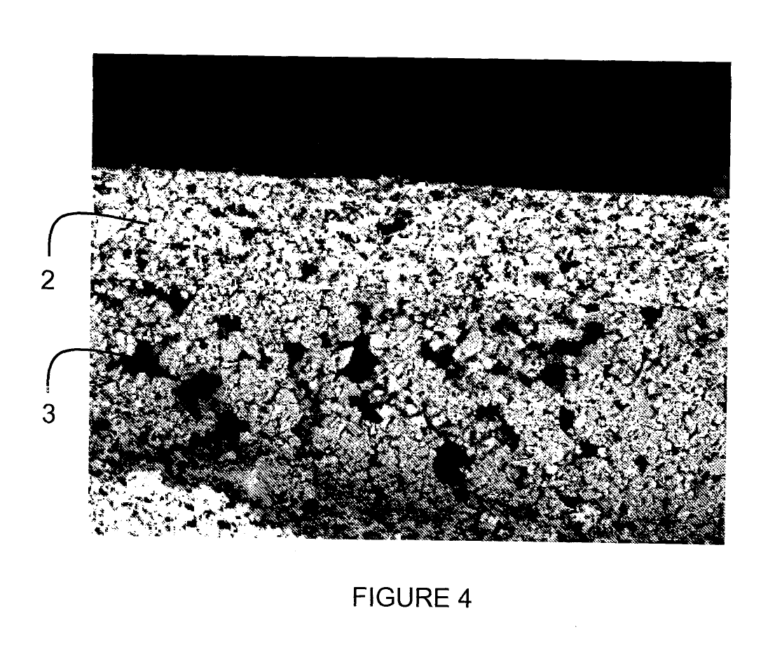

Detailed observation of the channels and plugs of the filter produced according to Example 2 by scanning electron microscopy, shown in FIG. 2, demonstrates the presence of cracks 11 between the wall 2 and the plug 3. The same analyses and examinations show no such defects on the filter produced according to Example 3. FIG. 3 shows the structural continuity between the walls 2 and the plugs 3, on the rear face, i.e. on the side opposite the bearing face of the filter during firing. FIG. 4 shows the junction between a wall 2 and a plug 3 on the front face. In the embodiment according to the invention, no cracks were observed between the plugs 3 and the walls 2 both on the front face and on the rear face.

Additionally, the filter produced according to Example 3 laden with 4 g/l of soot was tested on an engine test bed using a 2-liter direct injection diesel engine. This confirmed that the filtration efficiency, measured by a probe of the SMPS (Scanning Mobility Particle Sizer) type was satisfactory for this filter. The filter, subsequently subjected to a regeneration, showed no cracks after a visual inspection, demonstrating that this filtering structure is capable of being used to filter the exhaust gases of an internal combustion engine, in particular a diesel engine.

1. A process for obtaining a filtering structure, the process comprising:
forming a honeycomb structure;
firing a the honeycomb structure; and
plugging inlet and outlet channels, wherein:
a) one portion of the inlet channels is plugged on a first end before the honeycomb structure has been fired; and
b) a portion of the outlet channels is plugged on a second end after the honeycomb structure has been fired,
wherein the filtering structure is suitable for filtering a particulate-laden gas, and the filtering structure is in a honeycomb arrangement, comprising an array of longitudinal adjacent channels of mutually parallel axes separated by porous filtering walls, said channels being alternately plugged at the first or the second ends of the structure so as to define the inlet channels and outlet channels for the gas to be filtered and so as to force the gas to pass through the porous walls separating the inlet channels from the outlet channels.

2. The process of claim 1, wherein the material comprised in the plugs placed on the first end of the filter has substantially the same composition and is structurally continuous with the walls, and
wherein the plugs placed on the second end of the filter have at least one selected from group consisting of a different chemical composition and a different structural composition from those/that of the plugs placed on the first end.

3. A process for manufacturing a filtering structure, comprising:
a) preparing a composition comprising constituent material of the structure and forming a honeycomb structure;
b) drying the structure in air with at least one technique selected from the group consisting of hot-air drying, microwave drying, and freeze drying at a temperature below 130° C.;
c) preparing a composition of a first plugging material and sealing, on a first end of the structure, a portion of the channels with the composition;
d) optionally, air drying with at least one technique selected from the group consisting of hot-air drying, microwave drying, and freeze drying at a temperature below 130° C.;
e) firing the structure, to obtain a fired structure;
f) preparing a second plugging material composition and sealing with the second plugging material composition, a second end of the fired structure, of the channels not sealed off during c), to obtain plugs; and
g) at least one of drying and heat treating the plugs placed on the second end of the fired structure,
to obtain a filtering structure in a honeycomb arrangement, comprising an array of longitudinal adjacent channels of mutually parallel axes separated by porous filtering walls, said channels being alternately plugged at the first or the second ends of the structure so as to define the inlet channels and outlet channels for the gas to be filtered and so as to force the gas to pass through the porous walls separating the inlet channels from the outlet channels.

4. The process of claim 3, wherein the firing e) is carried out at a temperature between 1300° C. and 1800° C.

5. The process of claim 3, wherein the at least one of drying and heat treating g) comprises at least one drying operation selected from the group consisting of air drying, hot-air drying, microwave drying, and freeze drying at a temperature below 130° C.

6. The process of claim 3, wherein the at least one of drying and heat treating g) comprises at least one heat treatment at a temperature between 500° C. and 1100° C.

7. A filtering structure, obtained by the process of claim 1, comprising an array of longitudinal adjacent channels of mutually parallel axes separated by porous filtering walls,
wherein the channels are alternately plugged at a first or a second end of the structure so as to define inlet channels and outlet channels for the gas to be filtered and so as to force said gas to pass through the porous walls separating the inlet channels from the outlet channels,
wherein a material comprised in the plugs placed on the first end of the filter structure has substantially the same composition and is structurally continuous with the walls and in which the plugs placed on the second end of the filter structure have at least one selected from the group consisting of a different chemical composition and a different structural composition, from those/that of the plugs placed on the first end.

8. The filtering structure of claim 7, wherein a volume of at least one portion of the inlet channels is different, than that of at least one portion of the outlet channels.

9. The filtering structure of claim 7, wherein the porous walls comprise a material comprising aluminum titanate, a material comprising SiC that optionally further comprises at least one selected from the group consisting of a ceramic binder matrix and glassy binder matrix,
wherein the glassy matrix comprises SiO₂, an alumina-comprising material, or a cordierite-comprising material.

10. The filtering structure of claim 7, wherein the material comprised in the plugs has a chemical composition essentially identical to that of the material comprised in the porous walls.

11. The filtering structure of claim 7, wherein the material of the plugs of the first end and the material of the plugs of the second end have different chemical compositions.

12. The filtering structure of claim 7, wherein the material of the plugs of the first end and the material of the plugs of the second end have substantially the same chemical composition but a different structural composition.

13. The filtering structure of claim 7, further comprising a supported, or unsupported, active catalytic phase comprising at least one precious metal and optionally, an oxide.

14. An exhaust line, comprising the filtering structure of claim 7, wherein the second end constitutes an inlet face for at least one particulate-polluted exhaust gas, and
wherein the first end constitutes an outlet face for at least one pollution-free gas.

15. The method of claim 3, comprising, before the firing e), removing a binder.

16. A filtering structure, obtained by the process of claim 3 comprising an array of longitudinal adjacent channels of mutually parallel axes separated by porous filtering walls,
wherein the channels are alternately plugged at a first or a second end of the structure so as to define inlet channels and outlet channels for the gas to be filtered and so as to force said gas to pass through the porous walls separating the inlet channels from the outlet channels,
wherein a material comprised in the plugs placed on the first end of the filter structure has substantially the same composition and is structurally continuous with the walls and in which the plugs placed on the second end of the filter structure have at least one selected from the group consisting of a different chemical composition and a different structural composition, from those/that of the plugs placed on the first end.

17. The filtering structure of claim 16, wherein a volume of at least one portion of the inlet channels is different, than that of at least one portion of the outlet channels.

18. The filtering structure of claim 16, wherein the porous walls comprise a material comprising aluminum titanate, a material comprising SiC that optionally further comprises at least one selected from the group consisting of a ceramic binder matrix and glassy binder matrix,
wherein the glassy matrix comprises SiO₂, an alumina-comprising material, or a cordierite-comprising material.

19. The filtering structure of claim 16, wherein the material comprised in the plugs has a chemical composition essentially identical to that of the material comprised in the porous walls.

20. The filtering structure of claim 16, wherein the material of the plugs of the first end and the material of the plugs of the second end have different chemical compositions.
